(19) United States
(12) Patent Application Publication
(10) Pub. No.: US 2012/0323700 A1
(43) Pub. Date: Dec. 20, 2012

(54) IMAGE-BASED CAPTCHA SYSTEM

(76) Inventors: Prays Nikolay Aleksandrovich, Novosibirsk (RU); Nikiforov Igor Alekseevich, Novosibirsk (RU); Vladykin Maksim Vladimirovich, Novosibirsk (RU); Nikiforov Aleksey Igorevich, Novosibirsk (RU); Prays Varvara Borisovna, Novosibirsk (RU); Nikiforova Olga Igorevna, Novosibirsk (RU)

(21) Appl. No.: 13/528,373

(22) Filed: Jun. 20, 2012

Related U.S. Application Data
(60) Provisional application No. 61/498,827, filed on Jun. 20, 2011.

(51) Int. Cl. H04L 9/32; G06Q 30/02

(52) U.S. Cl. 705/14.69; 726/7

(57) ABSTRACT

A system and method for remote verification of human interaction without requiring the entering of alpha numeric characters using a keyboard.

### CROSS REFERENCE TO RELATED APPLICATIONS

This utility patent application claims priority to U.S. Provisional Patent Application Ser. No. 61/498,827 filed on Jun. 20, 2011, entitled “Image-Based CAPTCHA System,” the entire disclosure of the application being considered part of the disclosure of this application and hereby incorporated by reference.

### BACKGROUND OF THE INVENTION

1. Technical Field

The present invention generally directed to a system and method for remote verification of human interaction, without requiring entry of alpha-numeric characters via a keyboard. More specifically, the present invention uses specific interactions or tasks related to images, graphical representations, puzzles, or challenges without the need to enter characters through a keyboard, including virtual keyboards on a screen, and as such, is particularly suited for allowing easy remote verification of human interaction, and more particularly suited for devices that do not include physical keyboards, such as smart phones and tablets.

2. Related Art

Many website owners and operators desire for certain content to only be accessed by humans and to prevent access by automated systems, such as, search bots and spam bots. Website operators are particularly concerned with minimizing the effect of spam bots which create annoying or malicious content. For example, spam bots may add comments containing an advertisement (e.g. erectile dysfunction drugs); create new topics in the forums with ads or links; create links that point to resources which contain malicious code, such as viruses, worms, and Trojans; create new accounts on websites; and send private messages with annoying content to the actual human members of such websites. As spam bots have increased in sophistication, some spam bots can even make conversations with each other that fools real visitors. More specifically, a first spam bot creates a new topic in a forum: “Please, give me advice regarding the best windows,” and the second spam bot replies to the first: “I bought my windows from ABC Company, and I have no problems at all.” The above example is very simplistic and these conversations between spam bots may be much more complex, contain numerous messages (e.g. 50 and more), and include numerous different spam bots. It is increasingly becoming impossible to determine whether spam bots or humans are creating, much less carrying on a particular dialog.

Therefore, most website operators strive to prevent certain information, functions, privileges or areas from being available to automated systems. For example, it is generally desirable to prevent by automated systems online voting; posting in forums and blogs; posting of reviews; creating new registrations or accounts in forums, blogs, or any other websites. As used herein the terms “function” or “functioning” include submission of forms and data. One common way to differentiate a human from a computer is by a test known as a “Turing test.” When a computer program is able to generate the Turing test and evaluate the results, it is typically known as a CAPTCHA (completely automated public test to tell computer and humans apart) program. In addition to the general desire not have certain portions, functions, areas, content or privileges of a website freely available to automated systems, many websites use CAPTCHA programs to prevent attacks by malicious programs, including those that are designed to disrupt service on a large scale. For example, some individuals may write programs that automatically consume large amounts of a website's resources in denial of service attacks. To counter these denial of service attacks, some websites use CAPTCHA tests to ensure that the demand on a website is only legitimate human interactions. As such, website operators use CAPTCHA to minimize attacks, limit access to areas, functions, privileges and content of the website, prevent automated posting of information, and reduce online voting by automated systems by requiring human interaction for certain features or pages of a website. CAPTCHA systems can be used in a number of other settings to verify human interaction.

Currently, CAPTCHA systems act as an easy to implement, security mechanism which require a correct answer inputted by a website user or visitor, specifically by typing a word that is typically shown as text, an image of text, or an image having an object such as a dog where the visitor enters in the text the word “dog” or other text regarding some feature of the dog with alpha numerical keys on a keyboard. Therefore, the intent of a CAPTCHA-based security system is to generally pose a question or security protocol which only a human can answer and random guesses by automated systems are generally ineffective. All current CAPTCHA systems are text-based, such as where the visitor sees an image of various characters arranged together, typically as a distorted word or string of characters, and then the user enters that text using a keyboard.

One problem with current text-based CAPTCHA systems is that as object recognition has improved, specifically object character recognition techniques, many automated systems are now able to correctly enter the required text in the input box with a high degree of accuracy and thereby correctly answer the CAPTCHA system. As more and more automated systems are able to correctly complete CAPTCHA tests, website operators are increasingly distorting, bending, or adding different pixilated backgrounds to confuse object character recognition of automated systems. As object character recognition in automated systems is becoming increasingly accurate, website operators are increasingly resorting to distorted images of the text that a user needs to input with a keyboard, which causes high levels of frustration. Many humans now frequently enter incorrect text and require multiple attempts at verification before accessing the desired content. In some instances, the human trying to access a particular website becomes frustrated and gives up, which is not the result that the website owner or operator desires.

Website owners and operators are also frustrated because object character recognition has reached the point that even with heavy distortions, many automated systems have over an 88% accuracy in passing CAPTCHA security protocols with automated systems, and receiving access to secured portions of the website.

In addition, as the CAPTCHA systems use increasingly distorted text, various groups of the population with disabilities, as well as those with decreasing eyesight, increasingly have problems accessing the websites. Therefore, currently many CAPTCHA systems completely prevent certain people with disabilities, visual impairment, dyslexia or the like from accessing websites using CAPTCHA-based verification.

To address some of the problems with text-based CAPTCHA security systems, some website operators and owners have turned to image recognition. In the early state, the website owner would post a picture of an object, such as of a particular animal and the human to accessing the website would then select from a multiple choice list of which animal was displayed. Because these types of systems use multiple choices, the automated system would either recognize the picture of the animal or other object, or given the limited number of multiple choices, the automated systems could cycle quickly through each variation and quickly access the website. Once the correct answer was determined, the automated system would keep a record of which multiple choice answers was associated with a particular image for future access. Since these images were shared amongst various websites, very quickly the automated systems were able to successfully pass the test every visit. Another problem with the above described image recognition systems is that it is difficult for a small website to create a large volume of labeled images and therefore with a limited number of labeled images and without a means of automatically acquiring new labeled images, these image-based challenges were not usually meeting the definition or requirements of a CAPTCHA system. Typically, as these images required human labeling, it is doubtful that these systems even qualify as CAPTCHA systems.

To address these issues, instead of using multiple choice answers for a particular image, website owners and operators then focused on having the visitor identify color, textures, shapes, special points or features within the images and then type in an answer to a particular question. As these systems progressed, computers would automatically upload new images, identify the item to be identified within the image and then distort the image such that automated systems would have trouble identifying the item to be used in response to the question, while humans would still be able to recognize the original concept depicted within the distorted image. The problem with the use of any image-based system is that many times human visitors have different names for similar items, even if they all speak the same language. This problem is compounded for those people who do not speak the language in which the answer is required, those where the language in which the question is phased or the answer must be typed is a second language, or even native speakers with limited vocabularies. Even where the individuals speak the language, in many instances these types of image CAPTCHA systems are almost complete barriers to individuals who have below average or limited ability to read and write. Therefore, many of these image CAPTCHA-based systems not only have the same problems as traditional text-based CAPTCHA systems for those with disabilities and visual impairments, but also numerous additional problems for a far greater percentage of the population. In addition, many of these websites only have access to a limited number of labeled images and therefore as automated systems kept trying to access areas behind the CAPTCHA security system, databases of successful answers tied to specific images by automated systems were quickly developed, and as such these CAPTCHA systems quickly became ineffective.

To address the above problems with image-based CAPTCHA systems, or CAPTCHA like systems, some website owners and operators designed images or conglomerations of images that were distorted and then posed a question below asking the visitors to click on a selected area of the image, such as in a particular gird, particular color, or other identifying feature. While these systems allowed more possibilities for visitors to select, there are typically a finite number of questions that may be posed and automated systems have been able to learn break through these CAPTCHA systems.

Therefore, there is currently a need for a CAPTCHA system that allows improved access by humans, particularly those with disabilities, visual impairments, and reduced language skills as compared to the general population, while maintaining a better security rate and blockage of automated systems than any current CAPTCHA security system and built-in protections against easily learning circumvention techniques.

### SUMMARY OF THE INVENTION

The present invention generally directed to a system and method for remote verification of human interaction, without requiring entry of alpha-numeric characters via a keyboard. More specifically, the present invention uses specific interactions or tasks related to images without the need to enter characters through a keyboard and as such is particularly suited for allowing easy remote verification of human interaction, and more particularly suited for devices that do not include keyboards, such as smart phones and tablets.

The present invention is generally directed to a method for remote verification of human interaction comprising the steps of receiving a request for a CAPTCHA challenge with a CAPTCHA server; generating the CAPTCHA challenge; generating a unique identifier related to the CAPTCHA challenge; and storing a CAPTCHA challenge solution on a CAPTCHA server.

The method may also associate the unique identifier with the CAPTCHA challenge solution, as well as store the unique identifier related to the CAPTCHA challenge and the CAPTCHA challenge solution on the CAPTCHA server. Of course, it is expected that any replies from the client device, including a client solution, will also include the unique identifier.

The method also determines a mismatch between the stored CAPTCHA challenge solution and a client solution; generates a new CAPTCHA challenge; and sends the new CAPTCHA challenge to a client device. Displaying the new CAPTCHA challenge on the client device does not require refreshing of a webpage.

The CAPTCHA challenge generally includes one of a visual interactive task, a video, an audio instruction, an image, a graphical representation and moveable graphical elements. In addition, the CAPTCHA challenge does not include words or strings of alpha-numeric characters, and as such, does not require the inputting words or strings of alpha-numeric characters with a keyboard. Instead of alpha numeric characters, the CAPTCHA challenge is created by selecting a graphical representation and dividing into distinct graphical elements. The graphical elements may be different shapes. More specifically, the CAPTCHA challenge is configured to include a graphical representation and graphical elements which are capable of being rearranged to match the graphical representation. The graphical representation is used to generate graphical elements and wherein at least one of the graphical representation and the graphical elements are manipulated by at least one process of enlargement, rotation, shifting, or overlaying on different backgrounds. The graphical elements include edges which when arranged to match the graphical representation, may not be aligned. For example, gaps, overlays and other variances may be intentionally added.

The CAPTCHA challenge may include an image or graphical representation, which may instruct the client on how to manipulate the graphical elements and wherein the image is capable of being manipulated to match the graphical representation of the CAPTCHA challenge solution. The edges of the graphical elements may intentionally overlap, include spaces or other misalignments, such that if the graphical elements are aligned without overlap the client solution will not match the stored CAPTCHA challenge solution, and at least one of the graphical elements must be proper placed for a valid solution.

The CAPTCHA challenge generally includes a graphical representation and graphical elements and at least one of the graphical representation and graphical elements may be distorted such that the graphical elements created from the graphical representation are no longer identical, and when a client solution is assembled, it includes differences between the assembled graphical elements and the graphical representation. The challenge solution stored on the CAPTCHA server includes the graphical coordinates of the graphical elements, such as the graphical coordinates of the assembled graphical elements when the match the graphical representation or desired solution.

The client device after the challenge is solved by the client sends a verification request and the CAPTCHA server responds to a verification request by a client device of a client solution, including the unique identifier and any subsequent requests by a client device including the same unique identifier are ignored.

The present invention further includes a method for remote verification of human interaction further comprising the steps of, receiving a request with a CAPTCHA server for a CAPTCHA challenge; generating the CAPTCHA challenge; storing a CAPTCHA challenge solution on the CAPTCHA server; sending the CAPTCHA challenge; receiving a comparison request including a client solution from a client device; matching the received client solution to the stored CAPTCHA challenge solution; and determining one of a match or a mismatch between the stored CAPTCHA challenge solution and the client solution received in the step of receiving the comparison request.

The method may further include the steps of determining a mismatch between the stored CAPTCHA challenge solution and the client solution; sending a new CAPTCHA challenge solution to a client device; receiving a second comparison request for the client device, including a new client solution; and determining one of a match or a mismatch between the new CAPTCHA challenge solution and the new client solution received in the step of receiving the second comparison request. When a mismatch is determined a new challenge is sent and the new CAPTCHA challenge is capable of being displayed on the client device without refreshing of a webpage.

The method may further including the steps of: receiving a verification request from a secured website server and wherein the secured website server is not the device from which the first comparison request is received; receiving a verification client solution from a secured website server; and determining one of a match or a mismatch between the stored CAPTCHA challenge solution and the client solution received in the step of receiving the second comparison request. The step of receiving a verification client solution from a secured website server may include the steps of determining if the received client solution matches the verification solution, and that each of the received client solution and verification solution match the CAPTCHA challenge solution. In the receiving and determining steps, the unique identifier may be used in place or in addition to the client solution, any receive solution, and the stored solution.

The CAPTCHA challenge may include one of a visual interactive task, a video, an audio instruction, an image, a graphical representation and moveable graphical elements, and may be configured to not include words or strings of alpha-numeric characters, and not require the inputting with a keyboard of words or strings of alpha-numeric characters. More specifically, the CAPTCHA challenge may include an image having a graphical representation and the graphical elements are capable of being rearranged to match the graphical representation. The challenge may include instructions on how to manipulate graphical elements and the graphical elements are capable of being manipulated to match the graphical representation of the CAPTCHA challenge solution. The edges of the graphical elements include edges and the graphical elements are created such that when assembled to match the graphical representation, the edges are intentionally mismatched and if the edges are properly aligned, a submitted client solution will not match the CAPTCHA challenge solution. The challenge may include one of a visual interactive task, a video, an audio instruction, an image, a graphical representation and moveable graphical elements and wherein the visual interactive task, the video, the audio instruction, the image, the graphical representation and the moveable graphical elements cannot be reused on a webpage.

The present invention may include a method for remote verification of human interaction further comprising: requesting a CAPTCHA challenge with a client device; receiving the CAPTCHA challenge with a client device; displaying the CAPTCHA challenge on the client device; detecting activation of a submit control on the client device; initiating a verification process upon detecting activation of the submit control; and sending a first comparison request including a client solution. The step of initiating a verification process includes the step of verifying movement of each graphical element of the CAPTCHA challenge from an initial position. The client device may directed by a user to access a secured location on a secured website server, and wherein said secured website server may receive the client solution but does not compare the client solution to a CAPTCHA challenge solution. The client device may also send a client solution to a CAPTCHA server before the secured website server sends a verification request. The method is configured so that words or strings of alpha-numeric characters are not required, and as such the CAPTCHA challenge does not require the inputting with a keyboard of words or strings of alpha-numeric characters. In addition, the CAPTCHA challenge may include an image having a graphical representation and wherein the graphical elements are capable of being rearranged to match the graphical representation.

The present invention may include a method for remote verification of human interaction further comprising: loading a webpage on a client device; requesting a CAPTCHA challenge with the client device; receiving the CAPTCHA challenge with the client device; displaying the CAPTCHA challenge on the client device; detecting activation of a submit control; and sending a comparison request including a client solution to a CAPTCHA server upon detecting activation of the submit control and wherein sending of a comparison request including the client solution does not require refreshing of the webpage. It should be noted that as the client device never receives a solution to the challenge, the client device does not compare the client solution to any CAPTCHA challenge solution.

The present invention may further be directed to a method for remote verification of human interaction further comprising; sending a request for a CAPTCHA challenge from a client device to a CAPTCHA server; generating with the CAPTCHA server the requested CAPTCHA challenge; sending the CAPTCHA challenge from the CAPTCHA server to the client device; displaying the CAPTCHA challenge with the client device; detecting activation with the client device of a submit control; initiating a verification process with the client device upon detecting activation of the submit control; and verifying with the client device movement of each graphical element of the CAPTCHA challenge from an initial position. The CAPTCHA challenge may include one of a graphical representation of one of a product, a logo, a product name, an advertisement of a product or an advertisement of a service. The CAPTCHA challenge solution includes a link to a webpage.

The method may include the steps of: a website owner soliciting advertisers for advertising on a website, payment by a website owner for promoting specific ads, creating and placing the specific ads into a CAPTCHA service to distribute CAPTCHA challenges with the specific ads; and charging the website owner for distribution of the CAPTCHA challenges with the specific ads. Furthermore, the method may further include the steps of: an advertiser contacting an advertisement company with a specific advertisement campaign and creating an account with the advertisement company to pay for development and distribution of the specific advertisements, using a CAPTCHA service to distribute CAPTCHA challenges with the specific advertisements on various websites; and paying website owners for hosting the CAPTCHA challenges including the specific advertisements.

The present invention may also be directed to a system for providing CAPTCHA security to websites comprising: (1) a client device having a processor and a storage medium including machine readable instructions that when executed by a client cause the client device to load a webpage, including a CAPTCHA challenge; (2) a CAPTCHA server having a processor and a storage medium including machine readable instructions that when executed are capable of performing the steps of: generating a CAPTCHA challenge having a graphical representation and at least one graphical element that is capable of being rearranged; assigning a unique identifier to the generated CAPTCHA challenge; sending the CAPTCHA challenge and unique identifier to the client device in response to the client device loading the webpage; storing a solution to the CAPTCHA challenge with the unique identifier; receiving a client solution to the CAPTCHA challenge including the unique identifier from a client device; verifying that the client solution received including the unique identifier matches the stored CAPTCHA challenge solution with the same unique identifier; sending a response to the client device including one of an approval of the client solution, or a new challenge including a new unique identifier; and (3) a secured website server having a processor and a computer readable storage medium including machine readable instructions that when executed perform the steps of: sending the unique identifier to the CAPTCHA server for verification in response to receiving the unique identifier from the client device; receiving a verified match from the CAPTCHA server and granting access to the client device to the desired material, content, functions, or webpage.

### DETAILED DESCRIPTION OF THE PREFERRED EMBODIMENT

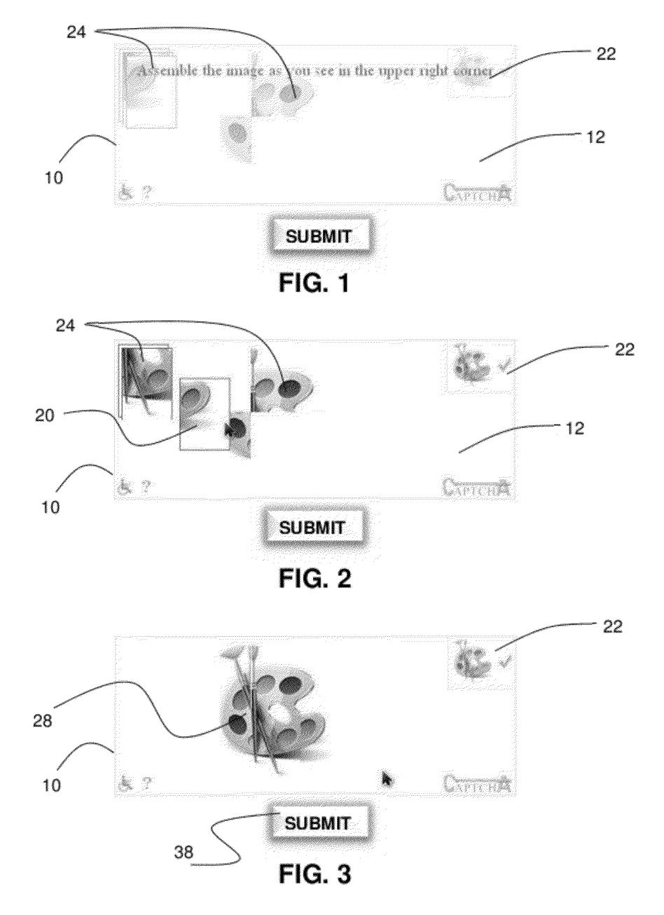

FIG. 1 is an exemplary puzzle image as presented originally to a client;

FIG. 2 is the puzzle image from FIG. 1 being assembled by the client;

FIG. 3 is the completed puzzle image of FIGS. 1 and 2;

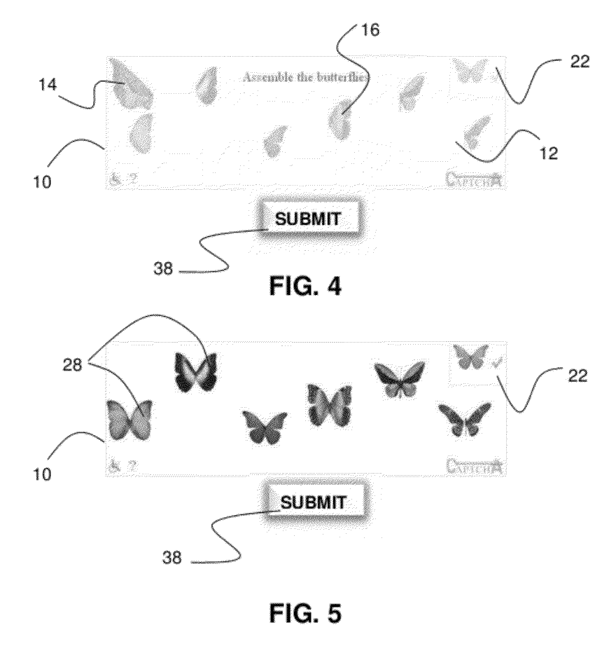

FIG. 4 is a graphical matching puzzle as presented originally to the client;

FIG. 5 is the completed puzzle from FIG. 4;

FIG. 6 is a second exemplary puzzle image as presented to the client;

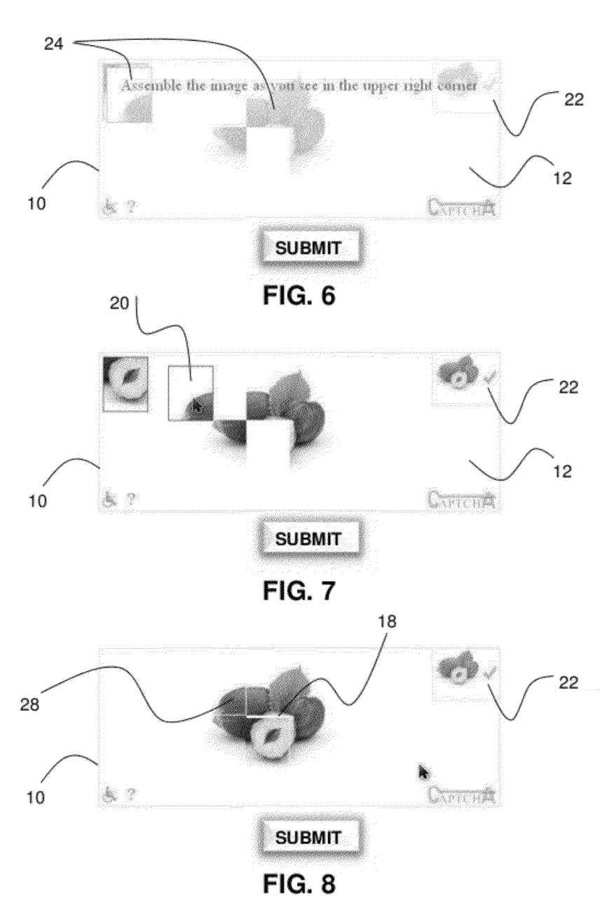

FIG. 7 is the puzzle being partially completed of the puzzle in FIG. 6;

FIG. 8 is a completed puzzle from FIG. 6 before verification;

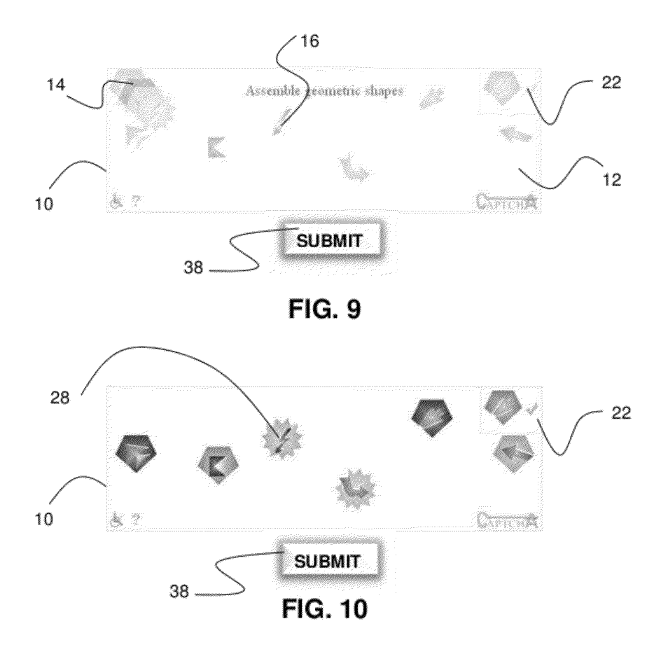

FIG. 9 is a puzzle of geometric shapes as presented originally to the client;

FIG. 10 is a completed puzzle from FIG. 9;

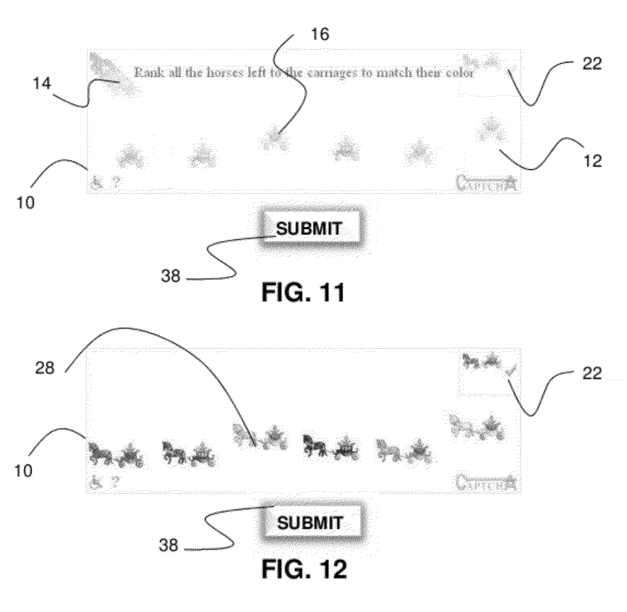

FIG. 11 is a color-matching puzzle as originally presented to the client;

FIG. 12 is a completed color-matching puzzle from FIG. 11;

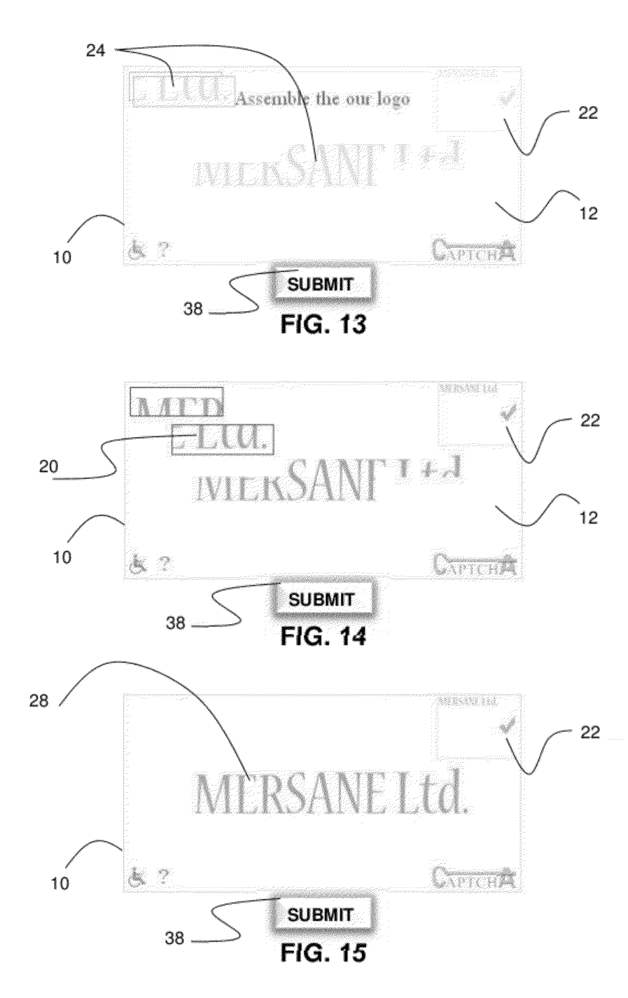

FIG. 13 is a logo assembly puzzle as originally presented to the client;

FIG. 14 is a partially completed logo assembly puzzle from FIG. 13;

FIG. 15 is a completed logo assembly puzzle from FIG. 13;

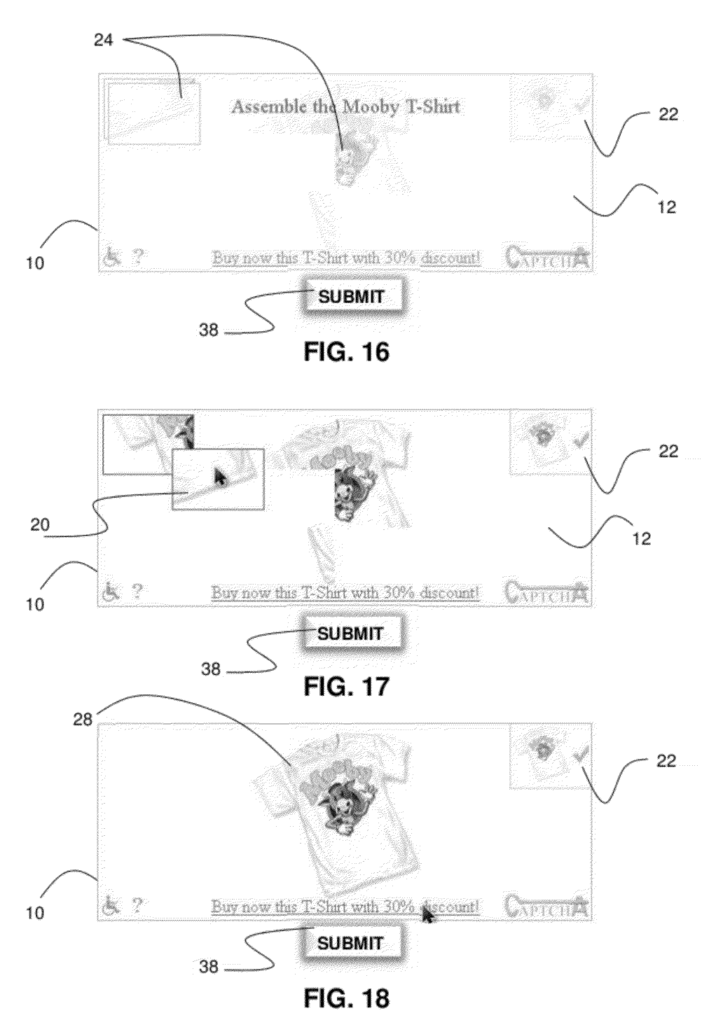

FIG. 16 is a merchandising puzzle as originally presented to the client;

FIG. 17 is a partially completed merchandising puzzle of FIG. 16;

FIG. 18 is a completed merchandising puzzle from FIG. 16;

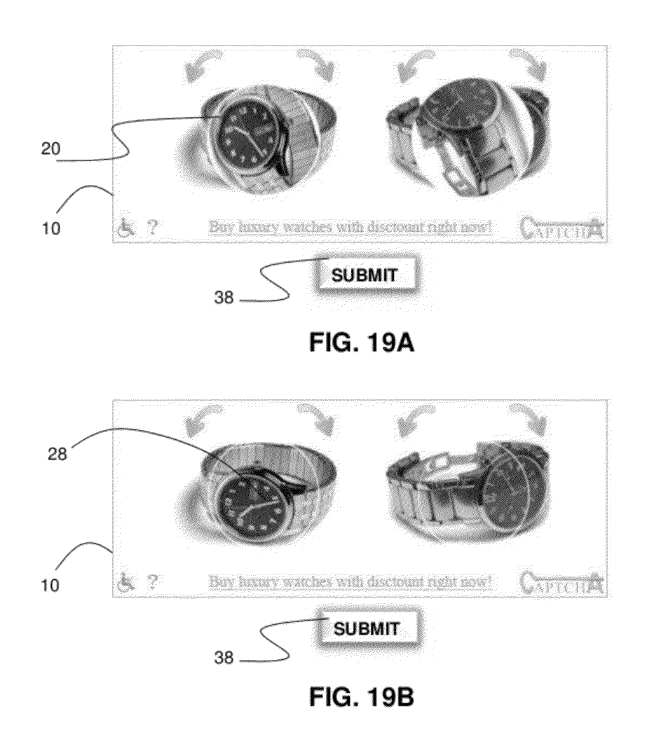

FIG. 19A is an illustration of a rotating puzzle as originally presented to the client;

FIG. 19B is an illustration of a rotating puzzle being solved;

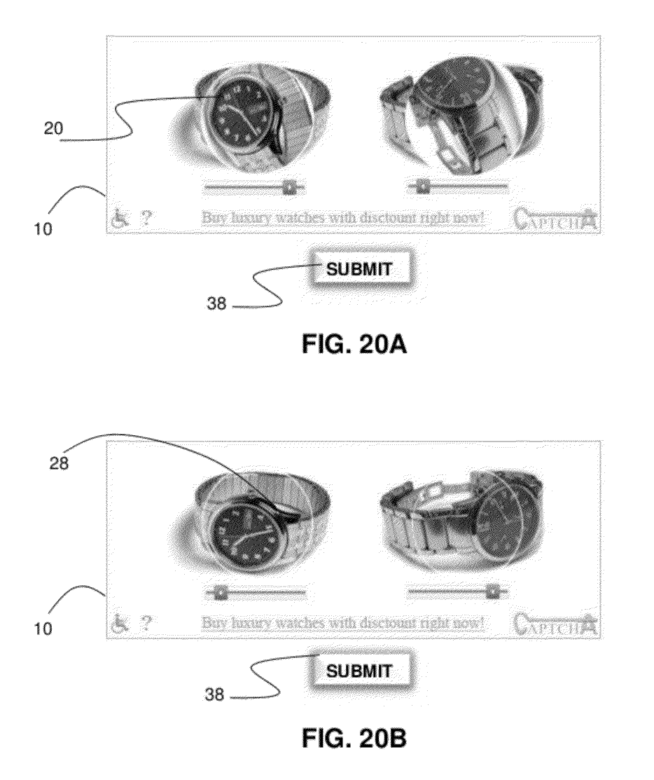

FIG. 20A is an illustration of a rotating puzzle as originally presented to the client using a sliding bar in place of the rotational arrows used in FIGS. 19A and 19B;

FIG. 20B is an illustration of a solved puzzle from FIG. 20A;

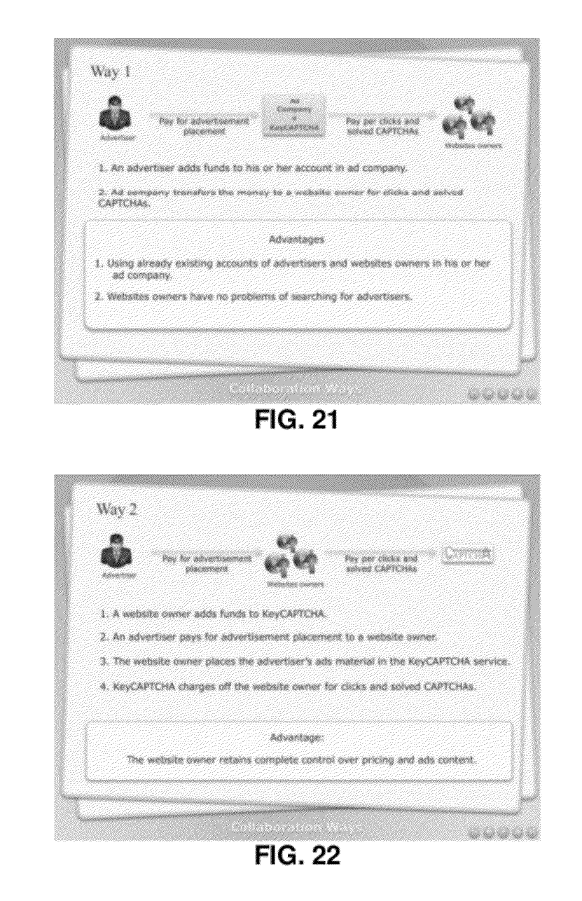

FIG. 21 is a screen shot of a method of using merchandising and marketing CAPTCHA systems;

FIG. 22 is a screen shot of a second method for using merchandising and marketing CAPTCHA systems;

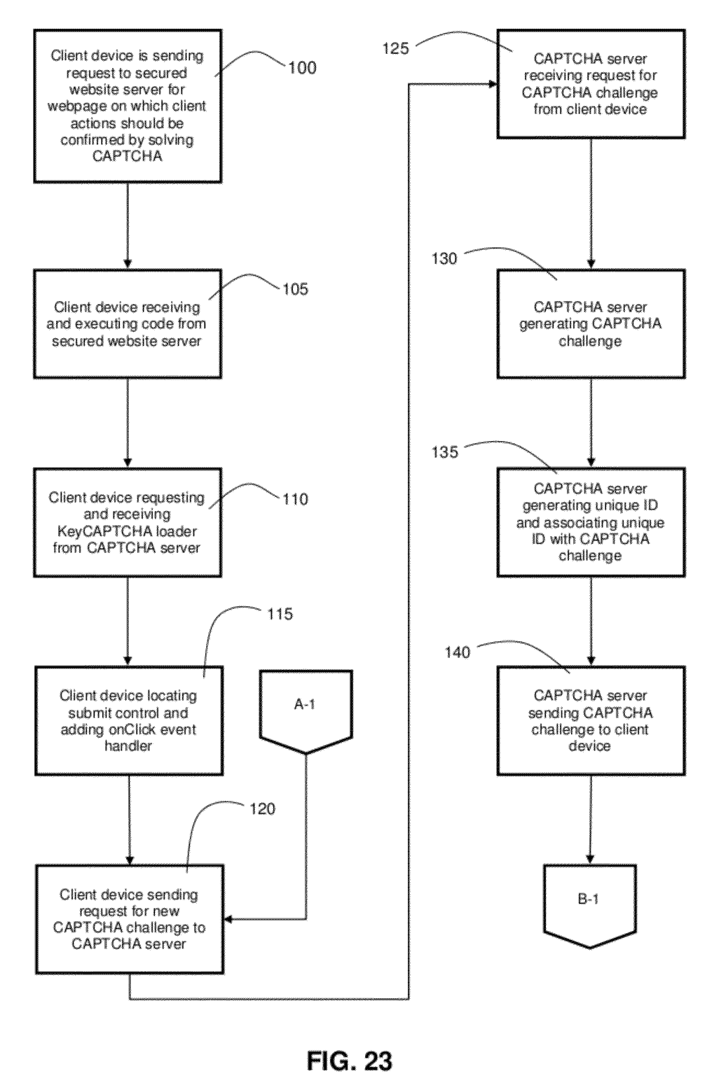

FIG. 23 illustrates steps 100-140 of remote verification of human interaction;

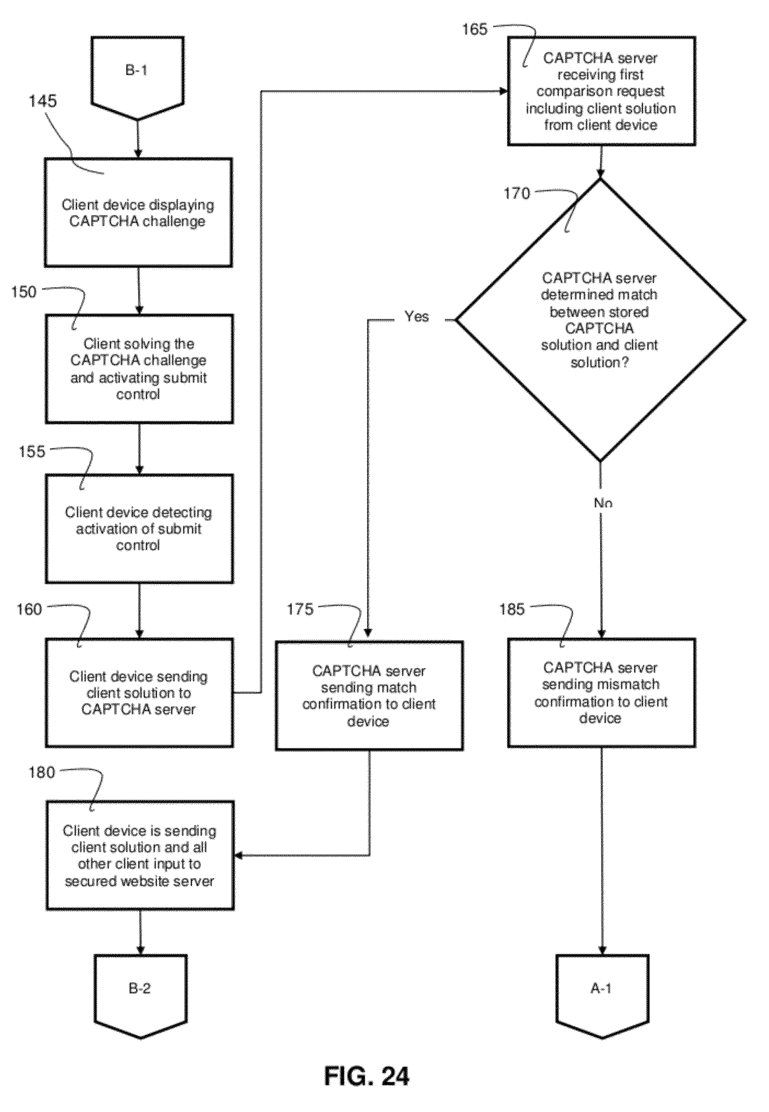

FIG. 24 illustrates steps 145-185 of remote verification of human interaction;

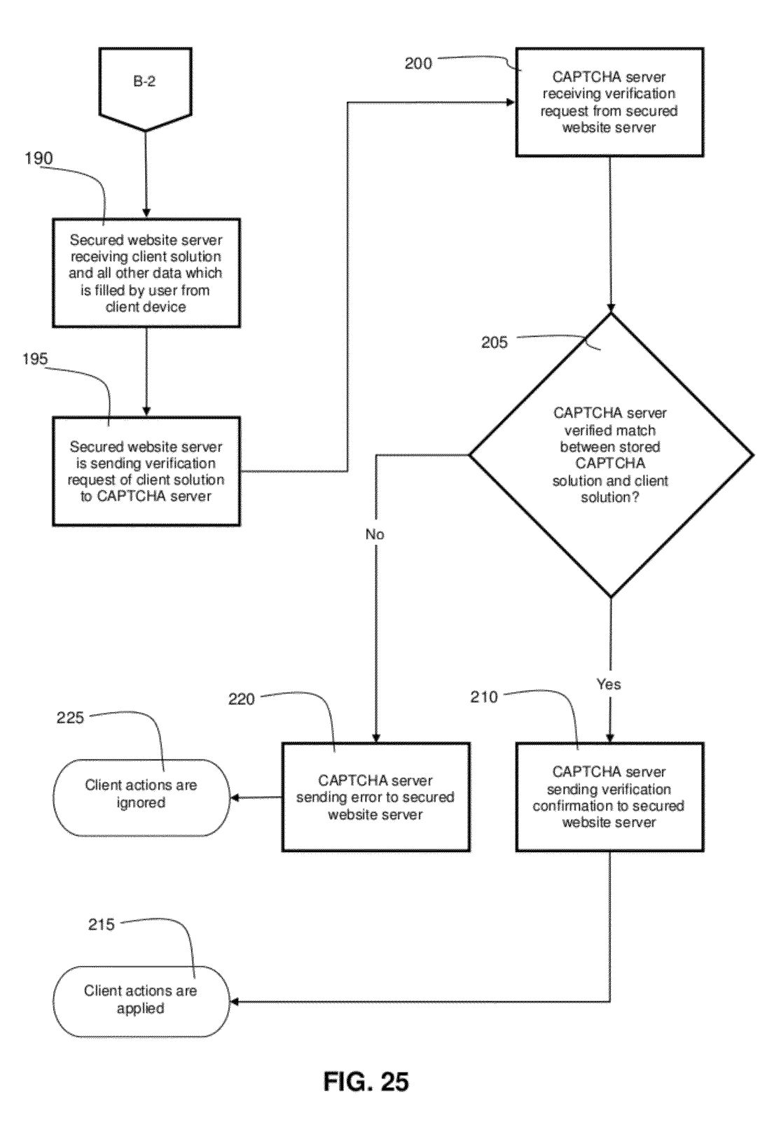

FIG. 25 illustrates steps 190-225 of remote verification of human interaction;

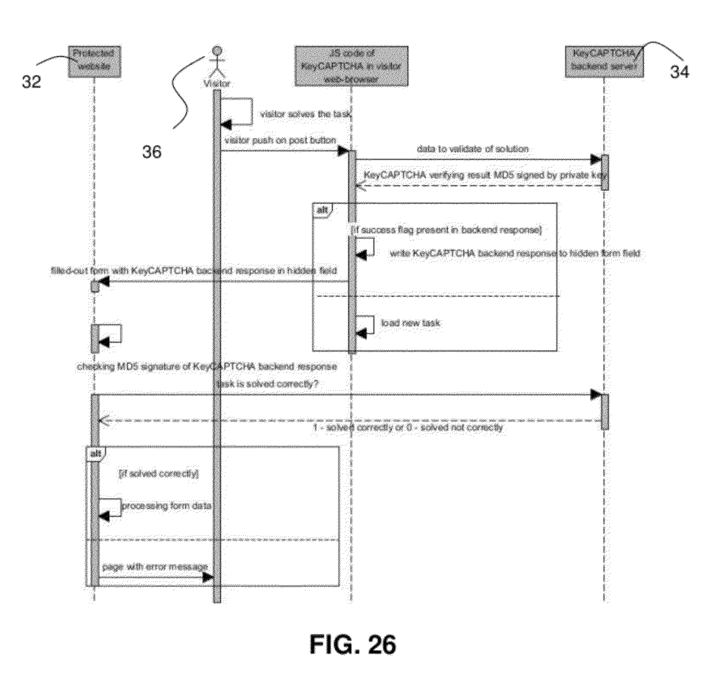

FIG. 26 illustrates a schematic diagram of the CAPTCHA system; and

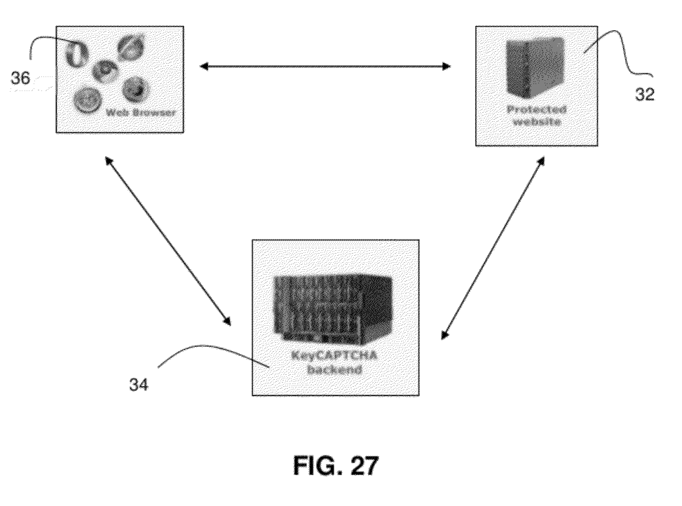

FIG. 27 illustrates the overall system involved in the CAPTCHA process.

### DETAILED DESCRIPTION OF THE PREFERRED EMBODIMENT

The present invention uses interactive challenges, such as puzzles, and manipulation of visual elements to create a CAPTCHA system that is extremely resistant to automated systems, easily updatable to prevent learning by automated systems, yet substantially easier for human visitors to successfully use. The present invention specifically provides CAPTCHA systems that reduce unwanted entry by automated systems while using the unique described methods below that result in easier to use CAPTCHA systems for disabled, visually impaired, children, dyslexic, people with difficulty in reading and responding to text-based inquiries, and those with below average reading and writing abilities. The present invention also allows website owners, operators, and third parties to capitalize financially on the required interaction by a website visitor and the CAPTCHA system of the present invention, and provides methods of verification that prevent circumvention of CAPTCHA systems, that may easily be adjusted in degree of difficulty of the challenges.

As illustrated in the Figures, the present invention provides a new type of website protection, specifically a new type of CAPTCHA system that protects websites and the like from unwanted access, such as automated systems like spam bots. A visitor to a website, hereinafter generally referred to as a client or user, attempts to access a secured area or secured content or perform a task or function that requires verification of human interaction. To obtain access to the desired website area, functionality or content, the client or user must solve a CAPTCHA challenge. Exemplary CAPTCHA challenges of the present invention are illustrated in FIGS. 1-21.

The CAPTCHA challenge 24 is typically presented to the user of the website within a specified area on the website page, such as in the exemplary box 10. Although the CAPTCHA challenge 24 is illustrated as being presented in a box 10, it may be easily displayed on the webpage without the box 10 or in a variety of other settings. As used herein the terms box, area and space occupied by the moveable pieces of the challenge may be used interchangeably. The box 10 generally contains a challenge 24, such as a puzzle, having a graphical representation 22 of the desired solution, and at least one graphical element 20 requiring manipulation or assembly, such as the illustrated puzzle pieces in in FIGS. 1-3.

The challenge 24 is initially presented to the client or user, as illustrated in FIG. 1, typically on an area of the page or in the illustrated box 10. The webpage containing the challenge 24 may be displayed on any device used by the client, including computers, tablets, smartphones and any other capable internet device. As described in detail below, a number of steps that are not visible to the user occur before the challenge 24 is presented to the client or user. These steps typically occur after a client's device requests access to the page and as the page loads on the client's device. The type of graphical representation 22 and graphical elements 20 may vary depending on the type of challenge 24 presented to the client. A number of exemplary challenges 24 are illustrated in the Figures. Although the graphical elements 20, such as the puzzle pieces requiring assembly, may be located anywhere within the box 10, they are illustrated as being located in the upper corner of the box 10. While the amount of assembly or manipulation may vary, such as requiring assembly of all of the graphical elements 20 to match the graphical representation 22, to reduce the amount of time required to complete the CAPTCHA challenge 24, as well as simplify the CAPTCHA challenge 24, some graphical elements 20, such as a couple of pieces of the puzzle illustrated in FIG. 1 may already properly positioned. To increase the difficulty of the challenge 24 for automated systems, a background 12, such as additional completed butterflies or portions of butterflies occurring in the background 12 but not part of the graphical elements 20, may be included. In addition, the graphical elements 20 presented with the challenge 24 may include extra graphical elements that are needed to complete the challenge by manipulation or assembly to match the graphical representation 22. As discussed in more detail below, the graphical elements 20 may vary in size, shape, and configuration, and may not match evenly or align to further confuse automated systems.

The challenge 24 is configured such that no keyboard, physical or virtual, is needed to complete the challenge 24. The challenge 24 may further be configured to avoid the required alpha numerical entries of current CAPTCHA systems, while yet avoiding the issues described in the Background related to image based systems. As illustrated in FIG. 2, the client is manipulating the graphical elements 20 by dragging a first graphical element 20, or a puzzle piece, toward the expected location on the bottom right-hand corner of the box 10. Because the challenges 24 do not require the use of alpha numeric character entry, such as by a keyboard, the present invention is well suited for use with client devices 36, such as tablets and smart phones. Any type of manipulation of the graphical elements 20 is acceptable, including mouse or finger on a touch screen. The client manipulates the graphical elements 20 of the challenge 24 to match the graphical representation 22, such as the illustrated image in the upper corner of the box 10. As further illustrated in FIGS. 3, 10 and 12, the client has moved or manipulated all of the graphical elements 20 or puzzle pieces to the proper position and perfectly assembled the puzzle such that a verification or submit control 38 may be pressed to check the correctness of the CAPTCHA assembly. While it is possible for the present invention to automatically submit a solution once the graphical elements are arranged or manipulated to the proper position, having the client manually submit the challenge 24 as a client solution 28 eliminates the possibility of automatic systems randomly moving the images about the box 10 until a successful solution is obtained. The submit button 38 is generally used to submit the arranged graphical elements 20 as a client solution 28 to a CAPTCHA server 34, typically just the coordinates of the graphical elements, which will then be matched to a stored solution. The submit button or control 38 may simply be clicking on the assembled graphical elements 20 or a separate button or link, as illustrated in FIG. 3. FIG. 3 further illustrates the client solution 28 matching the graphical representation 22. FIGS. 1-3 use puzzle pieces as the graphical elements 20, which may vary in size, shape, and configuration.

FIGS. 4 and 5 illustrate a different type of challenge 24 from the puzzle pieces in FIGS. 1-3. More specifically in FIGS. 4 and 5, the graphical representation 22 is an exemplary butterfly (or other object) and the moveable graphical elements 14 are laid next to stationary graphical elements 16 to create the illustrated solution in FIG. 5, which would be submitted as a client solution 28. Generally, once the client solution 28 is verified, authenticated or matched with a solution, the client may access the desired website, functionality, secured area, or content, similar to any other CAPTCHA system. FIGS. 9-10 and 11-12 show variations of FIGS. 4 and 5. Furthermore, the graphical representation 22 and elements 20 may form logos, slogans, products for sale, or other advertisements as illustrated in FIGS. 13-20.

Variations of each type of CAPTCHA challenge 24 may be used. As illustrated in FIGS. 6-8, a similar assembly of a puzzle to FIGS. 1-3 shows the acceptable client solution 28 may not have perfectly aligned graphical elements 20. More specifically, as shown in FIG. 8 the assembly of the CAPTCHA challenge 24 into a client solution 28 may be configured to not require exact assembly and allow for some gaps 18 or overlap between the edges of the graphical elements 20. The gaps 18 as illustrated in FIG. 8 allow a client to quickly assembly a puzzle to be close enough to the graphical representation 22, or the image in the upper right-hand corner that is the exemplary image, and upon submitting a verification request, such as submitting the client solution 28 to a CAPTCHA server 34, the client solution 28 is matched to a stored solution and the client is allowed access to the secured portions of the webpage 30.

Some key benefits to using the above CAPTCHA image system is that people who have reduced eyesight, are not good at reading languages, who do not completely understand a particular language or characters relating to text-based CAPTCHA, children, and those with disabilities such as dyslexia will have an easier time solving the presented task where a website uses the present invention. The present invention also allows a website operator, or the CAPTCHA server 34 operator to vary the amount of variance the graphical elements 20 have in placement, such that the task provided as a challenge 24 is considered to be solved or match a given solution, even if the client has not assembled the entire image or graphical elements 20 precisely. Another benefit to using the illustrated puzzle-based verification system is that many touch screen devices such as smart phones, music players, and tablets can be cumbersome in entering text-based CAPTCHA challenge solutions. A person with such a touch screen device simply has to manipulate the graphical elements 20, such as with a stylus or their finger, by dragging the puzzle pieces quickly to the desired locations to match the exemplary image or graphical representation 22 and successfully complete the CAPTCHA task presented as a challenge 24 in the box 10. It should be readily recognized that the challenge 24 illustrated in FIGS. 1-3, with three quick drags of the graphical elements 20 or pieces, provides a substantially faster completion of the CAPTCHA task and therefore reduces the time and frustration before the client may interact with the desired website.

To prevent spam bots from moving around graphical elements 20, such as puzzle pieces, until the assembly is automatically verified, the CAPTCHA instead does not provide a “correct” solution to the puzzle in the client's browser or to the client's device. This prevents spam bots from being able to find the solution by analyzing an HTML or Java Script code. Therefore, the present invention typically requires clicking of the verification or submit button 38 to minimize the capability of automated systems to solve the challenge 24, such as a puzzle. In addition, to prevent spam bots from learning correct solutions by resubmitting the same puzzle over and over again, the KeyCAPTCHA system instead allows the checking of a particular CAPTCHA on a particular website only once and all subsequent verification requests of the same CAPTCHA are banned or declared invalid by the system. Of course, after a predetermined amount of time or requests have occurred, or on a different website, the KeyCAPTCHA system could recycle a particular CAPTCHA puzzle. Of course, given that the system may take any image and automatically break it into graphical elements 20, such as a puzzle, the system could be configured to never recycle a particular CAPTCHA puzzle, even if the same base image is used as the graphical representation 22. In the instances where a marketing image is desired to be shown to the website visitor (as described in more detail below), the system can avoid the recycling of CAPTCHA puzzles by breaking the puzzle into an almost infinite number of shapes and sizes, such that the same CAPTCHA challenge 24 or puzzle is never represented to a website user, even if only a limited number of images are available for use. To provide further variations, the image could be enlarged, rotated, shifted slightly, or overlaid on different backgrounds to provide even more variations.

While dragging puzzle pieces to the correct locations, the system may be configured to allow approximately matching solutions to the exemplary image, thereby allowing for deviations and gaps, the size or magnitude of which are allowable may be set by the website owner or operator. It is also possible for the system to distort either the exemplary image or graphical representation 22 or the puzzle pieces or graphical elements 20 from each other such that a human would easily be able to complete the CAPTCHA, because such distortion would only provide low perceptual degradation while yet increasing the resistance to automated systems by increasing the differences between the graphical representation and graphical elements. In addition, the pieces or graphical elements may be configured with shapes that graphically match, such that the boundary of one graphical element 20 or puzzle piece overlays other graphical elements 20 or puzzle pieces, and may further include gaps, but the end image substantially matches the exemplary image or graphical representation 22.

FIGS. 4-5 and 9-12 provide other types of assembly puzzles and are provided as only exemplary style puzzles. In FIGS. 4 and 5, the client is presented with partial images on the background and then assembles or manipulates the graphical elements 20, such as the various butterflies, depending upon shape and color. In FIGS. 9 and 10, the client assembles or overlays certain geometric shapes and in FIGS. 11 and 12, ranks all of the horses and carriages to match their color. It should be readily recognized that the provided CAPTCHA challenges 24 or puzzles in FIGS. 1-3 and 6-8 are only exemplary as well as the additional puzzles in FIGS. 9-12 and 4-5 regarding the content of the challenge 24. One significant feature of the invention is the direct manipulation of images without the need to enter characters. More specifically, the present invention may allow the manipulation into puzzles or challenges of any type of images having graphical elements 10 which are then, through manipulation by a mouse, stylus, or finger, are manipulated to match a graphical representation 22 of the original image, all without any requirement to provide input through text or keyboard. In fact, the present invention may specifically exclude the use of keyboard to provide improved access for a wider reach of the population, including a wider range of devices including mobile systems such as tablets and smart phones.

The completion of the puzzles discussed above may also include marketing images such as logos of particular companies or products similar to the website. The present invention allows for the direct manipulation and engagement with a logo, product or other impression desired by the client and is significantly more engaging and impressionable than banner ads. More specifically, as illustrated in FIGS. 13-15, a client would perform the task of assembling a particular company's logo, thereby creating a higher desired interaction between the client and either the owner or operator of the website the visitor desires to visit or a third party who pays for placement of their logo or product. In today's advertising world, people are inundated with advertisements and images of logos, products, and services, and creating direct interactions with advertising, specifically partial images of marketing content that the client then assembles into the full image for verification creates a lasting interactive experience with the visitor. More specifically, the assembly of logos by website visitors is highly desirable for marketing purposes and provides an extra revenue stream that does not exist with the current CAPTCHA systems. The monetization of images and products is discussed in more detail below. In addition to logos of companies, companies may provide pictures of various products on the website that visitors are visiting or of third parties such as the exemplary t-shirt illustrated in FIGS. 16-18. In interacting with the CAPTCHA system, the visitor in FIGS. 16-18 assembles a picture of a t-shirt and upon check of the verification or even before then, has the ability to click a link within the verification CAPTCHA box 10 to buy the particular item. This allows many website owners and operators to provide links to various products and services that they place on sale before the visitor enters the secured areas of the website. It also provides the ability of websites that do not sell products directly, such as forum and blog websites, and more specifically, those that allow posting of material to the website, to provide images and logos of the website or products related to the forum, such that the visitor may desire to acquire in an interactive method not previously used. Therefore, goods, services or brand advertising may be performed as interactive tasks as part of the CAPTCHA system. No longer do visitors need to provide text or keyboard inputs to boring and distorted words or jumbled letters, but may interact with fun puzzles and other manipulation of images which also provide extra monetary benefit for the placement of certain products, logos, or advertisements. For example, a travel agency could place a scenic image on a travel information website that when clicked could offer a special price to the location of the image that was just assembled. Likewise, a soda company could capture the attention of a visitor in an engaging manner such as assembling the picture of a soda bottle. As described in relation to FIGS. 16-18 and in addition to the visual image of the interactive tasks, the tasks may include a link to a particular advertiser's website or to a product page on a website.

Additional types of puzzles may also be used such as those illustrated in FIGS. 19-20. In FIG. 19, a puzzle is presented to a visitor with part of the image rotated or slid out of synch with the other portions of the image. In FIG. 20, the visitor has clicked on the slide button and is adjusting the slide button to rotate the graphical element 20 into alignment. Once the graphical element 20 is slid to fit the desired location, the client clicks the verification or submit button 38. Other types of puzzles may also be used such as those that have sliding bars throughout the image and the visitor slides the bars into particular alignment to create a desired image.

FIG. 21 illustrates an exemplary way for an advertising company to capitalize on ad placement as well as provide payment to website owners. An advertiser contacts the ad company and outlines the type of campaign they would want and places funds into an account with the ad company. The ad company then places various approved CAPTCHA puzzles on websites and for each solved CAPTCHA puzzle or even clicks onto the CAPTCHA puzzle, the ad company pays the website owners hosting the CAPTCHA puzzle including the desired advertising content, as a way to count the number of interactive viewings by website visitors. It is likely that the advertiser would pay more for specific clicks to advertising links that redirect the website visitor to specific products or services. In a second method, as illustrated in FIG. 22, a website owner may retain complete control over the pricing and ad content through directly soliciting advertisement from third parties. The advertiser would then pay an advertisement fee to the website owner and the website owner creates or places the advertiser's desired ad material into CAPTCHA service. The CAPTCHA service then charges the website owner for clicks and for use of the CAPTCHA service. It should also be noted that in relation to FIGS. 21 and 22, the advertiser may additionally pay for the CAPTCHA service used by the website owner. In some instances, the website owner may also directly pay the CAPTCHA service for placement of their own ads on their own web page and such payment relates to the running of the CAPTCHA system thereby freeing the website owner or operator to focus on only the content related to the website. By allowing each website owner as well as advertisers to create their own CAPTCHA puzzles easily for inclusion into the CAPTCHA system of the present invention, particularly those related to marketing, products and services, the ability of automated systems to keep up with the ever increasing number of CAPTCHAs, given the wide variety of types of images that would be used, is limited. In creating the CAPTCHA type puzzle, a marketer or website owner would submit a copy of an image to the CAPTCHA system wherein the CAPTCHA system would automatically enter and upload the image into the database and then create the desired puzzle.

To further improve the marketing and consumer interaction with the CAPTCHA system when the image is uploaded into the CAPTCHA database, the marketing system may set parameters such as the types of websites that may display the CAPTCHA ad such as limiting a particular ad to the food, beverage, and entertainment industries, or other ads to travel websites. Furthermore, it is expected that an advertising company or website owner or operator may be able to set the type of manipulation or how the image is divided into graphical elements, such as a puzzle to improve or obtain the desired interaction with the image by the end visitor or consumer. By providing more options for the advertiser or website owner related to the interaction to and manipulation of the image as part of the CAPTCHA service and verifying human interaction, these interactions become more valuable to the advertiser and website owner and therefore generally are expected to have a higher placement cost than just banners which at most are only fleeting in their impression. In fact, the images used for particular CAPTCHA could come through similar advertisement systems in place for banners such that the website owner allocates a portion to the CAPTCHA and a portion to the banner ads.

FIGS. 23-27 illustrate a schematic diagram of the verification process. More specifically, the diagrams reflect that the CAPTCHA system protects a website provider from a number of undesirable items or prevents access to certain websites or content. Such undesirable items were discussed above in detail, but generally include integration of spam into webpage 30, fake (i.e. automatic system submitted) registrations, online voting, login requests, posts, new topic, conversation requests or threads. The CAPTCHA system may also be used to protect financial accounts from attempted login by automated systems, such as using hacked passwords and user IDS which are not matched. In general, and as discussed above, before access is given to certain functionality, secured pages or content, the client or user must complete a CAPTCHA challenge 24 on a secured website. Once the client has “solved” the challenge 24, the client solution 28 is submitted by the client pressing a submit button 38 or link. As discussed below, the CAPTCHA server 34 then verifies, authenticates or matches the client solution 28 to a stored CAPTCHA challenge solution 26 before access is granted to the client.

One unique beneficial feature of the present invention, is that the client solution 28 is fully verified and matched to a stored CAPTCHA challenge solution 26 before any website data, such as filled in forms are sent or submitted. This allows verification of a client solution 28, without having to repopulate data in forms, if a mistake is made. Nothing is more frustrating than having a CAPTCHA error and having to fill out forms again such as account registrations. In comparison, current CAPTCHA systems are typically a separate page, required to be completed before access is even granted to the form to be filled out. For example, access to the USPTO Public PAIR is protected by a CAPTCHA challenge 24, and to avoid the requirement of resubmitting data filled out in a form (such as application number on the website page following the CAPTCHA challenge), a separate CAPTCHA only challenge 24 webpage is required. The present invention eliminates the need for a separate webpage or requiring resubmission and re-entry of all data in a form. As such, the present invention reduces the number of page loads required, which reduces data usage for mobile devices, delays in loading pages and frustration by clients or users of websites. More specifically, the present invention allows verification, matching or authenticating of a proposed client solution 28, before sending web-form data or other CAPTCHA protected data to the secured website. More specifically, if the proposed client solution 28 is not verifiable, does not match or is not authenticated, only a new challenge 24 will be provided to the box 10, with the rest of the page staying as is. As such, if a visitor or client did not solve the task correctly, the method allows a client to see a new task or challenge 24 without requiring HTML-page refreshing.

FIGS. 23-27 also illustrate the overall system involved in the present invention's CAPTCHA process. The system includes any web browser or any other software application used in retrieving, sending, and traversing information on the internet or any other network using Internet Protocol technology where human interaction is desirable to be verified. The client as part of step 100 in FIG. 23 will direct the web browser to visit a secured website, represented by the secured website server 32. The secured website server 32 hosts the secured website and generates an MD5 signature to protect all transferred data between the secured website, the client's web browser, and the CAPTCHA server 34. It is important to note that the CAPTCHA server 34 is not the secured website server 32. The secured website server 32 may be any type of server or system capable of retrieving, sending, storing, or processing digital requests, including virtual versions thereof. During method as described below, the web browser on the client device and the secured server may interface with the CAPTCHA server 34. The CAPTCHA server 34 generally is any server or system capable of retrieving, sending, storing, or processing digital requests.

FIG. 23 illustrates the step of the request process 100 where a client directs the web browser to retrieve information from the secured website. More specifically, FIG. 23 illustrates the method where the client's web browser sends a request for information to the secured website server 32, as part of loading a desired web page. While the request is illustrated in FIG. 23 as a request for an HTML page, the present invention may work with a variety of other formats and programming languages used to develop content for the internet and having various file extensions including but not limited to php, cgi, and xml, and the method of the present invention is not limited to an HTML page request.

The request is followed by the secured website server 32 generating an MD5 signature based upon the website's private key in response to receiving a request for the webpage 30. An MD5 is a result of cryptographic hash function. More specifically, the MD5 algorithm is a way to verify data integrity, and is more reliable than checksum and many other commonly used methods. However, any references to MD5 signatures in this application may be replaced with any other method of verification data integrity.

The secured website server 32 responds to the client's browser request for access by providing the client device 36 with packets of data that include a portion of the executable code for the CAPTCHA program, as per the step 105, written in JavaScript, as well as the MD5 signature. The client's web browser receives the CAPTCHA program, however, the CAPTCHA image is not yet displayed on the client's web browser.

FIG. 23 illustrates, following the loading of the CAPTCHA program in the client's web browser, the step 105 of the client's web browser at the direction of the CAPTCHA program sending a request to the CAPTCHA server 34 to retrieve the KeyCAPTCHA loader for execution on the client's web browser. Such request includes the MD5 signature.

FIG. 23 further illustrates in step 110 that the CAPTCHA server 34 responds to the request from the client device 36 or the client's web browser by sending the KeyCAPTCHA loader. Such response includes a newly generated MD5 signature created by the combination of the client's internet protocol address, the secured website's URL and an encryption value.

FIG. 23 also illustrates step 115 in which the CAPTCHA program in the client device 36 or the client's web browser attempts to locate a submit control 38 in the web form or other CAPTCHA secured task on the secured website. As such, adds an onClick event handler to the submit control 38. The CAPTCHA program on the client device 36 or in the client's or client's web browser then accepts the KeyCAPTCHA loader.

FIG. 23 illustrates in the step 120 that once the CAPTCHA program is loaded on the client device 36, it sends a request via the client's web browser to the CAPTCHA server 34 for a CAPTCHA challenge 24. Such request includes the MD5 signature.

The CAPTCHA server 34 accepts the MD5 signature and verifies that such signature was generated by the secured website server 32. Upon verification of the MD5 signature, the CAPTCHA server 34 generates a CAPTCHA challenge and a unique identifier 40 for the CAPTCHA challenge 24, are illustrated in the step 130 of the FIG. 23. The generated CAPTCHA challenge, specifically the graphical representation 22 and graphical elements 20 used in the CAPTCHA challenge 24, are sent to the client's or client's web browser, along with the unique identifier 40. The CAPTCHA server 34 associates the unique identifier 40 with the generated CAPTCHA challenge 24 as illustrated in step of FIG. 23, such that if a challenge 24 reuses the same image (for example the illustrated t-shirt), the particular challenge 24 sent to the client device 36, when returned as a client solution 28 may be easily identified and matched with a stored solution with the unique identifier 40. This is particularly relevant when different challenges 24 use the same base image or graphical representation 22, but vary the graphical elements 20.

FIG. 23 illustrates the CAPTCHA server 34 either sending to the client's web browser on the client device 36 the CAPTCHA challenge 24, such as the CAPTCHA image, as per step 140, or an error message notifying the user that the MD5 signature does not match. The error message may be any desired message. Such request includes the MD5 signature. Of course, the system may resend a new challenge 24, as discussed above, for a limited number of tires.

Because the present invention does not require the reloading or resubmission of the entire page, if the client solution 28 is incorrect, the user or client may complete a web form or other CAPTCHA protected task on the secured website, on the same page as the CAPTCHA challenge 24. As such, the user would also complete the CAPTCHA task and press the submit control 38, such as the submission button 38. In pressing the submit control 38, only the client solution 28 is required to be sent, and the rest of the page, including any completed forms may stay static, as illustrated in the step 150 of FIG. 24.

In step 155, as illustrated in FIG. 24, the CAPTCHA program on the client device 36 detects an activation of the submit control 38. The CAPTCHA program then checks whether the user completed the CAPTCHA task such as, for example, the user moved all of the graphical elements 20, a sufficient number of the graphical elements, or even the requisite graphical elements of the CAPTCHA challenge 24 from their original location. When the client presses or activates a submit control 38, such as a submit button 38, the handler of an even onClick is executed. Ensuring at least some movement of the graphical elements 20 at the client device level reduces demand on the CAPTCHA server 32 of false submitted requests and mistaken submits by the client. The handler is part of KeyCAPTCHA javascript code.

As illustrated in step 160 of FIG. 24 the CAPTCHA program on the client device 36 via the client's web browser sends an encrypted request to the CAPTCHA server 34 to verify the client solution 28. Such request includes the client solution and the MD5 signature.

The CAPTCHA server 34 accepts the MD5 signature and verifies that such signature was generated by the secured website server 32. FIG.24 illustrates in steps 165 and 170 that the CAPTCHA server 34 may confirm that the client solution constituting a proposed solution to a given CAPTCHA challenge 24 submitted by the client is correct by comparing, verifying, matching or authenticating the client solution 28 submitted by the client against the stored CAPTCHA challenge solution 26. More specifically, the CAPTCHA solution stored on the CAPTCHA server 34 and associated with the unique identifier 40, as described above, are both compared, matched, verified, or authenticated against the client solution and associated unique identifier 40 sent by the client device.

While the CAPTCHA server 34 could store the actual graphical solution, such as an image, on the CAPTCHA server 34, it typically saves the coordinates (of the moveable objects) when the CAPTCHA challenge 24 is being formed in the step 130 of FIG. 23, and not an image of the solution for each challenge. The coordinates define a correct CAPTCHA challenge solution 26 of the generated CAPTCHA challenge 24. Therefore, when the client solution 28 is being checked, the CAPTCHA server 34 compares the coordinates of the objects or graphical elements 20 sent from the visitor's or client's device with the coordinates saved in the CAPTCHA server 34. The use of coordinates, instead of an image for verification, improves the ability of the CAPTCHA systems to verify solved CAPTCHAs or CAPTCHA challenges 24, even if the website visitor or client has completed the task inaccurately. In fact, the use of coordinates for verification also allows website operators and the CAPTCHA system to easily define to what extent inaccuracies are allowed, and verify client solutions as needed. More specifically, if a particular website is under attack by spam bots, it may be helpful to temporarily tighten the restrictions by reducing the amount of inaccuracies that are allowed in a solved CAPTCHA challenge 24, such as CAPTCHA puzzle. In some embodiments, the restrictions may also be tightened at the client level in step 155 in verifying all graphical elements have been moved, even though no solution is located on the client device. The CAPTCHA server 34 encrypts the response and sends it to the client's devices, such as to the client's web browser. In addition, the use of coordinates, instead of images, reduces the storage requirements for the vast numbers of stored challenges 24 on the CAPTCHA server 34, and also reduces the amount of data that needs to be exchanged between the CAPTCHA server, secured server, and client device. In some instances, the client solution 28 will not include the assembled image, but only provide back graphical coordinates of the rearranged graphical elements 20. As mobile devices become commonplace, the present invention reduces the amount of data that needs to be communicated.

FIG. 24 also illustrates that the CAPTCHA server 34 responding to the client's web browser on the client device 36 with a statement as to whether the client solution, or more specifically, or the client solution 28 coordinates submitted by the client matched the stored solution, or more specifically, the stored CAPTCHA image coordinates located on the CAPTCHA server 34. Such response includes the MD5 signature, which will be verified. As discussed above, any other form of data integrity verification may be used in place MD5.

FIG. 24 further illustrates in step 175 that if the client solved the CAPTCHA task or the CAPTCHA challenge 24 correctly, the CAPTCHA program resumes and allows client's web browser on the client device 36 to proceed with the submission of the web form or other CAPTCHA protected task to the secured website via the secured website server 32. As illustrated in step 185 of FIG. 24, if the client did not solve the CAPTCHA challenge 24 or the CAPTCHA task correctly, then the CAPTCHA program on the client device 36 resumes and the client is presented with a different CAPTCHA challenge 24, including a different associated unique identifier 40. As such, steps 120-165 of FIGS. 23-24 would be repeated. The different challenge 24 may be presented without reloading the whole web page.

If the client solution is verified, authenticated, matched, or approved, the client's web browser then sends data, to the secured web site server 32, specifically a request containing the data of the filled out form, and the data received in the course of CAPTCHA. More specifically, the data would include the client solution and the unique identifier 40 generated in the step 135 of FIG. 23, so that the secured server may verify with the CAPTCHA server that the client can proceed. Of course, the system may only require the client device to provide the unique identifier 40 to the secured website server 32. The secured website server 32 receives and disassembles the reply received from the visitor's or client's web browser into the web form or other CAPTCHA protected task and the CAPTCHA task response or the client solution 28, as per step 190 of FIG. 25.

The secured website server 32 then sends a request to the CAPTCHA server 34 and such request includes the unique identifier 40 generated in step 135 of FIG. 23. In some instances, it may also include the client solution. In step 200 of FIG. 25 the CAPTCHA server 34 accepts the unique identifier 40 generated in step 135 of FIG. 23, and using this unique identifier 40, the CAPTCHA server 34 then locates the CAPTCHA verification result according to its unique identifier 40 in its internal database (the verification result is stored in the database). If the unique identifier 40 is found in the database, including successful completions of challenges, the CAPTCHA server 34 generates a reply to be sent to the secured website. The CAPTCHA server 34 may also delete the CAPTCHA according to its unique identifier 40, and the unique identifier 40 from the database.

In step 205 the CAPTCHA server 34 sends the response generated to the secured website server 32, such as a positive or negative authentication, verification, or matching result. While the response, as shown herein, was for the CAPTCHA being solved correctly as per step 210 of FIG. 25 and for a CAPTCHA challenge 24 being solved incorrectly as per step 220, such response may be sent using various alpha-numeric combinations.

The secured website server 32 accepts the response from the CAPTCHA server 34 and reads the response to determine whether the client solved the CAPTCHA challenge 24 or task correctly. If the CAPTCHA server 34 responded that the client processed the CAPTCHA task correctly, then the client's web form data or other CAPTCHA protected task is processed, as illustrated in the step 215 of FIG. 25. If the CAPTCHA server 34 responded that the client processed the CAPTCHA challenge 24 task incorrectly, then the server generates a message that the client did not solve the CAPTCHA image correctly. This extra security step prevents hacking of the challenge 24.

The FIG. 26 illustrates a schematic diagram of the CAPTCHA system and method illustrated in FIGS. 23-25. More specifically, the diagram reflects that the access by automated systems into a secured website page or other CAPTCHA protected task on a secured website is performed by handling onClick events of a submit button or link and verifying the task or challenge solution before sending secured webpage data or other CAPTCHA protected data to the to the protected web site. If a client did not solve the task correctly, the method allows a client to see a new task or challenge without requiring page refreshing.

The FIG. 27 illustrates the overall system 8 involved in the present invention's CAPTCHA process steps 100-225, as illustrated in FIGS. 23-25. The system 8 includes any web browser located on client device 36 requesting access to protected website that is in turn maintained or hosted by the secured website server 32. In some circumstances the server hosting the website may be different than the secured website server 32. The CAPTCHA server 34 generates the CAPTCHA challenge in response to request from the client device 36, and sends it to the client device 36. The CAPTCHA server is also illustrated as being in communication with the secured website server 32 to verify successful completions of challenges by the user of the client device 36.

What is claimed is:

1. A method for remote verification of human interaction comprising:
receiving a request for a CAPTCHA challenge with a CAPTCHA server;
generating the CAPTCHA challenge;
generating a unique identifier related to the CAPTCHA challenge; and
storing a CAPTCHA challenge solution on a CAPTCHA server.

2. The method as set forth in claim 1 further comprising associating the unique identifier with the CAPTCHA challenge solution.

3. The method as set forth in claim 1 further comprising storing of the unique identifier related to the CAPTCHA challenge and the CAPTCHA challenge solution on the CAPTCHA server.

4. The method as set forth in claim 1 further comprising the steps of:
determining a mismatch between the stored CAPTCHA challenge solution and a client solution;
generating a new CAPTCHA challenge; and
sending the new CAPTCHA challenge to a client device and wherein displaying the new CAPTCHA challenge on the client device does not require refreshing of a webpage.

5. The method as set forth in claim 1 wherein the CAPTCHA challenge includes one of a visual interactive task, a video, an audio instruction, an image, a graphical representation and moveable graphical elements.

6. The method as set forth in claim 1 wherein the CAPTCHA challenge does not include words or strings of alpha-numeric characters.

7. The method as set forth in claim 1 wherein the CAPTCHA challenge does not require the inputting words or strings of alpha-numeric characters with a keyboard.

8. The method as set forth in claim 1 wherein the CAPTCHA challenge is created by selecting a graphical representation and dividing into distinct graphical elements.

9. The method as set forth in claim 1 wherein the graphical elements may be formed with different sizes and shapes.

10. The method as set forth in claim 1 wherein the CAPTCHA challenge includes a graphical representation and graphical elements which are capable of being rearranged to match the graphical representation.

11. The method as set forth in claim 1 wherein the graphical representation is used to generate graphical elements and wherein at least one of the graphical representation and the graphical elements are manipulated by at least one process selected from the group consisting of enlargement, rotation, shifting, or overlaying on different backgrounds.

12. The method of claim 8 wherein the graphical elements include edges and wherein when the graphical elements are arranged to match the graphical representation, the edges are not aligned.

13. The method as set forth in claim 1 wherein the CAPTCHA challenge includes an image having instructions of how to manipulate the graphical elements and wherein the image is capable of being manipulated to match the graphical representation of the CAPTCHA challenge solution.

14. The method as set forth in claim 1 wherein edges of the graphical elements intentionally overlap such that if aligned without overlap the client solution will not match the CAPTCHA challenge solution.

15. The method as set forth in claim 1 wherein the edges of the graphical elements of the client solution include intentional misalignments, wherein the misalignments include spaces, overlaps, varying gaps and wherein without such misalignments, the client solution will match the CAPTCHA challenge solution.

16. The method as set forth in claim 1 wherein the CAPTCHA challenge includes a graphical representation and graphical elements and wherein at least one of the graphical elements must be properly placed for a valid solution.

17. The method as set forth in claim 1 wherein the CAPTCHA challenge includes a graphical representation and graphical elements and wherein at least one of the graphical representation and graphical elements are distorted such that the graphical elements created from the graphical representation are no longer identical.

18. The method as set forth in claim 1 wherein the CAPTCHA challenge solution stored on the CAPTCHA server consists of graphical coordinates of the graphical elements.

19. The method as set forth in claim 1 wherein the CAPTCHA server responds to a verification request by a client device of a client solution, including the unique identifier and any subsequent requests by a client device including the same unique identifier are ignored.

20. A method for remote verification of human interaction further comprising:
receiving a request with a CAPTCHA server for a CAPTCHA challenge;
generating the CAPTCHA challenge;
storing a CAPTCHA challenge solution on the CAPTCHA server;
sending the CAPTCHA challenge;
receiving a comparison request including a client solution from a client device;
matching the received client solution to the stored CAPTCHA challenge solution; and
determining one of a match or a mismatch between the stored CAPTCHA challenge solution and the client solution received in the step of receiving the comparison request.

21. The method of claim 20 including the steps of:
determining a mismatch between the stored CAPTCHA challenge solution and the client solution;
sending a new CAPTCHA challenge solution to a client device;
receiving a second comparison request for the client device, including a new client solution; and
determining one of a match or a mismatch between the new CAPTCHA challenge solution and the new client solution received in the step of receiving the second comparison request.

22. The method as set forth in claim 21 further comprising in response to a determined mismatch, a new CAPTCHA challenge is sent to the client device and wherein said new CAPTCHA challenge is capable of being displayed on the client device without refreshing of a webpage.

23. The method as set forth in claim 20 further including the steps of:
receiving a verification request from a secured web site server and wherein the secured website server is not the device from which the first comparison request is received;
receiving one of a verification client solution or unique identifier from a secured website server; and
determining one of a match or a mismatch between the stored CAPTCHA challenge solution and the client solution or the stored unique identifier and the unique identifier received from the secured website server, received in the step of receiving the second comparison request.

24. The method of claim 20 wherein said step of receiving one of a verification client solution or a unique identifier from the secured website server includes the steps of determining at least one of if the received client solution matches the verification solution and the unique identifier matches the stored unique identifier, and that each of the received client solution and verification solution match the CAPTCHA challenge solution, and that all received solutions are associated with the same unique identifier.

25. The method as set forth in claim 20 wherein the CAPTCHA challenge includes one of a visual interactive task, a video, an audio instruction, an image, a graphical representation and moveable graphical elements, and wherein solving the CAPTCHA challenge does not require the inputting with a keyboard of words or strings of alpha-numeric characters.

26. The method as set forth in claim 20 wherein the CAPTCHA challenge does not include words or strings of alpha-numeric characters.

27. The method as set forth in claim 20 wherein the CAPTCHA challenge includes an image having a graphical representation and wherein the graphical elements are capable of being rearranged to match the graphical representation.

28. The method as set forth in claim 20 wherein the CAPTCHA challenge includes instructions on how to manipulate graphical elements and wherein the graphical elements are capable of being manipulated to match the graphical representation of the CAPTCHA challenge solution.

29. The method as set forth in claim 20 wherein edges of the graphical elements include edges and the graphical elements are created such that when assembled to match the graphical representation, the edges are intentionally mismatched and if the edges are properly aligned, a submitted client solution will not match the CAPTCHA challenge solution.

30. The method as set forth in claim 20 wherein the CAPTCHA challenge includes one of a visual interactive task, a video, an audio instruction, an image, a graphical representation and moveable graphical elements and wherein the visual interactive task, the video, the audio instruction, the image, the graphical representation and the moveable graphical elements cannot be reused on a webpage.

31. A method for remote verification of human interaction further comprising:
requesting a CAPTCHA challenge with a client device;
receiving the CAPTCHA challenge with a client device;
displaying the CAPTCHA challenge on the client device;
detecting activation of a submit control on the client device;
initiating a verification process upon detecting activation of the submit control; and
sending a first comparison request including a client solution.

32. The method of claim 31 wherein said step of initiating a verification process includes the step of verifying movement of each graphical element of the CAPTCHA challenge from an initial position.

33. The method of claim 31 wherein the client device is directed by a user to access a secured location on a secured website server, and wherein said secured website server receives the client solution but does not compare the client solution to a CAPTCHA challenge solution.

34. The method of claim 31 wherein the client device sends a client solution to a CAPTCHA server before the secured website server sends a verification request.

35. The method as set forth in claim 31 wherein the CAPTCHA challenge does not include words or strings of alpha-numeric characters.

36. The method as set forth in claim 31 wherein the CAPTCHA challenge does not require the inputting with a keyboard of words or strings of alpha-numeric characters.

37. The method as set forth in claim 31 wherein the CAPTCHA challenge includes an image having a graphical representation and wherein the graphical elements are capable of being rearranged to match the graphical representation.

38. A method for remote verification of human interaction further comprising:
loading a webpage on a client device;
requesting a CAPTCHA challenge with the client device;
receiving the CAPTCHA challenge with the client device;
displaying the CAPTCHA challenge on the client device;
detecting activation of a submit control; and
sending a comparison request including a client solution to a CAPTCHA server upon detecting activation of the submit control and wherein sending of a comparison request including the client solution does not require refreshing of the webpage.

39. The method as set forth in claim 38 wherein the client device does not compare the client solution to any CAPTCHA challenge solution, and wherein a secured website server is not the device from which the first comparison request is sent.

40. The method as set forth in claim 38 wherein the CAPTCHA challenge does not require inputting with a keyboard or similar device words or strings of alpha-numeric characters.

41. A method for remote verification of human interaction further comprising:
sending a request for a CAPTCHA challenge from a client device to a CAPTCHA server;
generating with the CAPTCHA server the requested CAPTCHA challenge;
sending the CAPTCHA challenge from the CAPTCHA server to the client device;
displaying the CAPTCHA challenge with the client device;
detecting activation with the client device of a submit control;
initiating a verification process with the client device upon detecting activation of the submit control; and
verifying with the client device movement of each graphical element of the CAPTCHA challenge from an initial position.

42. The method as set forth in claim 41 wherein the CAPTCHA challenge may include at least one of a graphical representation of one of a product, a logo, a product name, an advertisement of a product or an advertisement of a service, and a link to a webpage.

43. The method as set forth in claim 41 further comprises the steps of:
a website owner soliciting advertisers for advertising on a website;
payment by a website owner for promoting specific ads;
creating and placing the specific ads into a CAPTCHA service to distribute CAPTCHA challenges with the specific ads; and
charging the website owner for distribution of the CAPTCHA challenges with the specific ads.

44. The method as set forth in claim 41 further comprises the steps of:
an advertiser contacting an advertisement company with a specific advertisement campaign and creating an account with the advertisement company to pay for development and distribution of the specific advertisements;
using a CAPTCHA service to distribute CAPTCHA challenges with the specific advertisements on various websites; and
paying website owners for hosting the CAPTCHA challenges including the specific advertisements.

45. A system for providing CAPTCHA security to websites comprising:
a client device having a processor and a storage medium including machine readable instructions that when executed by a client cause the client device to load a webpage, including a CAPTCHA challenge;
a CAPTCHA server having a processor and a storage medium including machine readable instructions that when executed are capable of performing the steps of:
generating a CAPTCHA challenge having a graphical representation and at least one graphical element that is capable of being rearranged;
assigning a unique identifier to the generated CAPTCHA challenge;
sending the CAPTCHA challenge and unique identifier to the client device in response to the client device loading the webpage;
storing a solution to the CAPTCHA challenge with the unique identifier;
receiving a client solution to the CAPTCHA challenge including the unique identifier from a client device;
verifying that the client solution received including the unique identifier matches the stored CAPTCHA challenge solution with the same unique identifier;
sending a response to the client device including one of an approval of the client solution, or a new challenge including a new unique identifier;
a secured website server having a processor and a computer readable storage medium including machine readable instructions that when executed perform the steps of:
sending the unique identifier to the CAPTCHA server for verification in response to receiving the unique identifier from the client device; and
receiving a verified match from the CAPTCHA server and granting access to the client device to the desired material, content, functions, or webpage.
